(19) United States
(12) Patent Application Publication
(10) Pub. No.: US 2010/0117357 A1
(43) Pub. Date: May 13, 2010

(54) FLEXIBLE VACUUM CLEANER HOSE COUPLING

(76) Inventor: Andrew C. Hyatt, Palm City, FL (US)

Correspondence Address: ROBERT M. SCHWARTZ, P.A., P.O. BOX 221470, HOLLYWOOD, FL, 33022, US

(21) Appl. No.: 12/638,370

(22) Filed: Dec. 15, 2009

Related U.S. Application Data
(63) Continuation of application No. 11/625,409, filed on Jan. 22, 2007, now abandoned.

(51) Int. Cl. F16L 33/00; B23P 17/04

(52) U.S. Cl. 285/240; 29/428

(57) ABSTRACT

The present invention is a coupling used for connecting two rigid vacuum cleaner hoses.

### INDEX TO RELATED APPLICATIONS

This application is a continuation of U.S. patent application Ser. No. 11/625,409 filed Jan. 22, 2007, the disclosure of which is incorporated herein by reference in its entirety.

### BACKGROUND OF THE INVENTION

The first manually-powered cleaner using vacuum principle was the “Whirlwind”, invented in Chicago in 1869 by Ives W. McGaffey. The machine was lightweight and compact, but was difficult to operate because of the need to turn a hand crank at the same time as pushing it across the floor.

In 1906, James Murray Spangler invented an electric vacuum cleaner from a fan, a box, and a pillowcase. In addition to suction, Spangler's design incorporated a rotating brush to loosen debris. The Spangler machine was the first of the Hoover vacuums.

Since the introduction of the electric vacuum, there have been numerous devices introduced as accessories for various cleaning purposes.

Rigid and non-rigid vacuum hose attachments help provide vacuum suction and cleaning in areas that are generally difficult for the machine to reach. One area that has not been addressed is the need for a rigid hose that has the ability to bend in order to reach under articles without the need for the user to bend excessively.

There is a need for such an attachment or device.

### BRIEF SUMMARY OF THE INVENTION

The many commercially available vacuum cleaner attachments have failed to address the need provided for in the present invention. That is, to vacuum under articles using rigid hose attachments whereby there is a need for at least one flexible portion in the assembly.

In one embodiment, the present invention provides
A coupling for connecting two vacuum cleaner hoses comprising:
   (a) a first open end;
   (b) an elongated columnar body portion that is rigid and maintains substantially planer external surface orientation, said body portion encompassing an inner cavity; and
   (c) a second open end.
The coupling has an elongated columnar body portion that may be flexible by virtue of a plurality of radial surface indentations. Alternatively the coupling may have an elongated columnar body portion that comprises an internal spring about the perimeter to allow flexation.

In one embodiment, the coupling has a substantially planer external surface orientation is altered by application of pressure to produce flexation. That is that the outer edge of the coupling extending between each of the two end portions is substantially a 180° angle. When pressure is applied to the coupling, an angle of flexation of approximately 180°-90° may be produced.

The coupling is so formed as to receive, at each of said openings, rigid vacuum cleaner hoses. The coupling is further constructed such that the interior portion of said transverse portions maintains lateral integrity when subject to interior vacuum force of conventional vacuum cleaners. That is to say, the interior portions of the coupling are not drawn inward towards each other when subjected to the force of a conventional vacuum cleaner.

Also contemplated is a method for using vacuum cleaner hose extensions comprising:
(d) attaching a first rigid vacuum cleaner hose to one end of a flexible vacuum coupling of;
(e) attaching a second rigid vacuum hose to a second end of a flexible vacuum coupling;
(f) attaching one end of either said first or said second rigid vacuum hose to a source of vacuum;
   using said first and said second rigid vacuum hoses connected with said flexible coupling to vacuum under articles with clearance between said article and a vacuuming surface.

### BRIEF DESCRIPTION OF THE DRAWINGS

FIG. 1 shows a side perspective view of the coupling in a flexed position.

FIG. 2 is a cut away of the side perspective view of the coupling in a non-flexed position exposing interior springs.

FIG. 3 shows the coupling with a 90 degree angle of flexation.

FIG. 4 shows the coupling in the environment of use.

FIG. 5 shows the coupling with a ball and socket arrangement for flexation.

FIG. 6 shows an embodiment whereby one end is a male connector and one end is a female connector.

FIG. 7 shows a ball and socket arrangement with a cut away to show a spring.

### DETAILED DESCRIPTION OF THE PREFERRED EMBODIMENTS

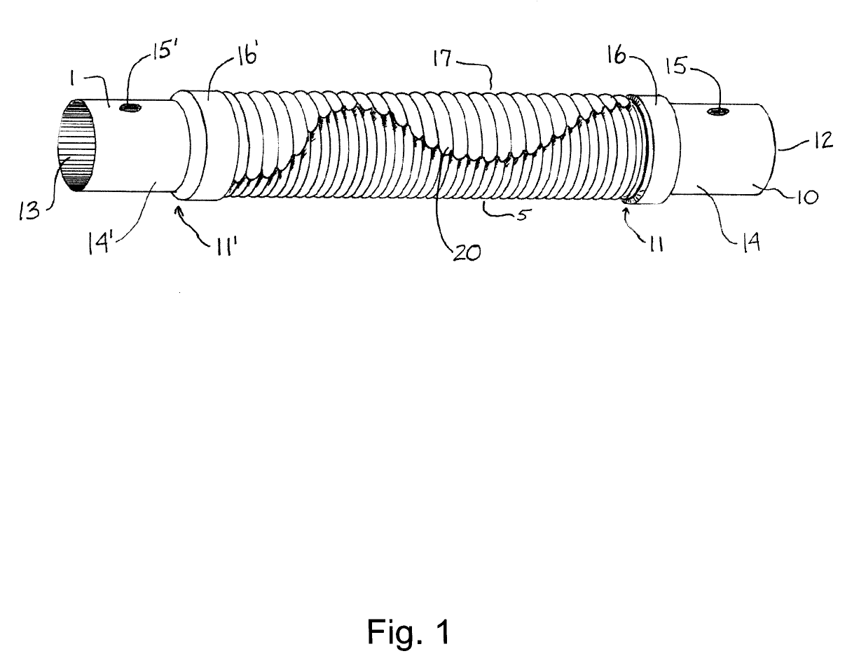

The coupling of the present invention provides a novel device for joining two vacuum cleaner hoses. Referring to FIG. 1, the user joins conventional vacuum cleaner hoses or attachments using coupling 10. Coupling 10 has a first end 11 and a second end 11′. First end 11′ has opening 12 and second end 11′ has opening 13 which define an internal cavity. First end 11 has a connector portion 14 and second end 11′ has a connector portion 14′. The connectors may be configured such that either one or both are male connectors, either one or both are female connectors, or one connector is male and one connector is female. Each of connector portions 14 and 14′ have a protrusion 15 and 15′ respectively that extends upward from the connector surface and engages in a locking manner the desired hose or attachment. In a preferred embodiment, the coupling of the present invention is used to join to rigid hoses. The coupling further comprises collars 16 and 16′ that permanently fastens each of ends 14 and 14′ to an elongated columnar hose, or body 17. The elongated columnar body is also permanently attached on either end to each of collars 16 and 16′. When pressure is applied to the coupling 10, a vertex is created in vertex region 18 that is substantially at or near the midpoint of coupling 10. The coupling will bend along vertex region 18 and create an angle of flexation θ from the aforementioned application of force. The coupling is so constructed such that when no force is applied, the coupling maintains a substantially straight orientation such that angle θ is approximately 180°. The internal cavity defined by the interior of ends 11, 11′ and elongated columnar body has a circular cross sectional area defined by the formula Πr². The elongated columnar body 17 is further so formed such that when the coupling 10 is subjected to internal force from a conventional vacuum cleaner. That is to say the inner cavity maintains substantially the same cross sectional area and the interior portion of elongated columnar body 17 does not collapse inward. Typically, conventional vacuum cleaners produce about −20 kiloPascal (kPa) of vacuum force. The cross sectional area is only reduced when a user applies pressure on one of ends 11 or 11′ and an angle of flexation θ is produced. In a preferred embodiment the cross sectional area is reduced by up to 80%.

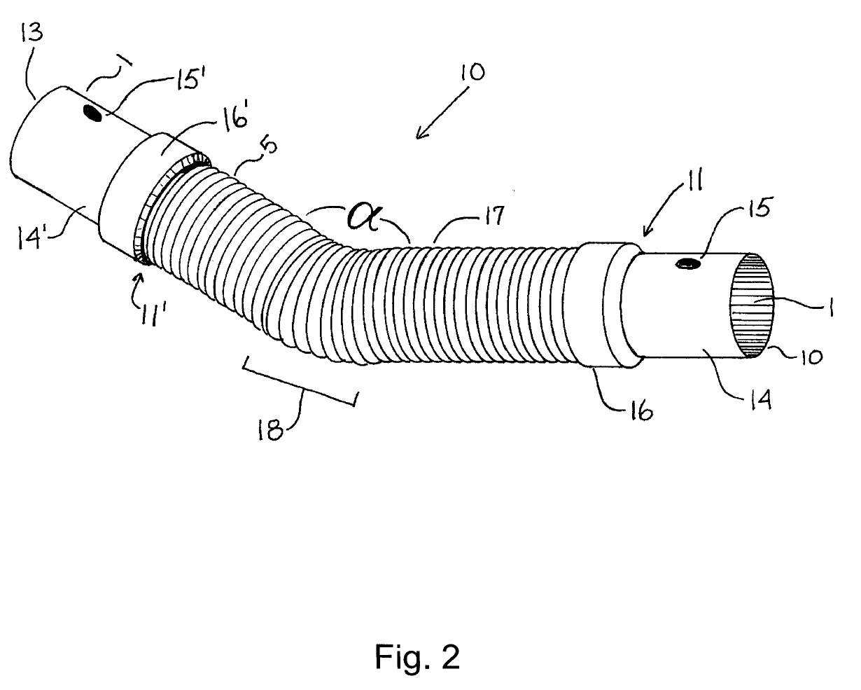

In one embodiment, shown in FIG. 2, depicts a cut away of the coupling of the present invention. The coupling 10 comprises a plurality of spring coils 19 that are encased by a cover 20 that extends the length of elongated columnar body 17. In a preferred embodiment, the spring coils 19 are formed of metal. However, any material known in the art to produce a spring mechanism as desired in the present invention may be used. In a preferred embodiment, the cover 20 is plastic. However, the cover may be constructed of any appropriate material as determined by one of ordinary skill in the art.

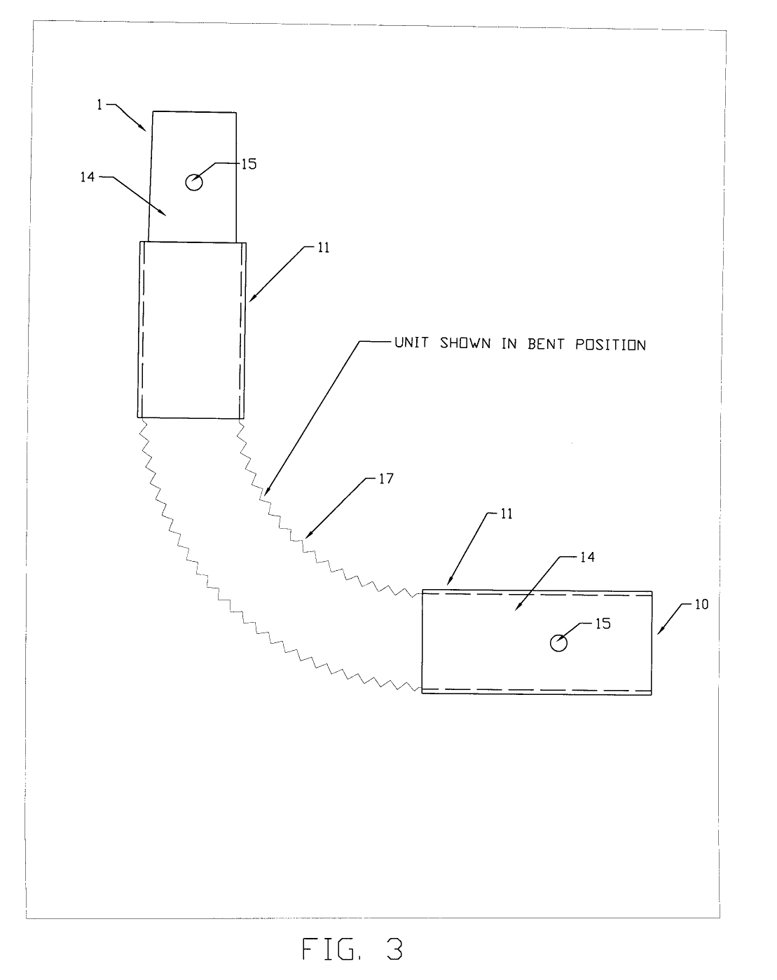

As shown in FIG. 3, the coupling of the present invention may undergo an angle of flexation of up to approximately 90° without crimping. The interior of the coupling substantially retains the circumference of the article in a non-flexed position.

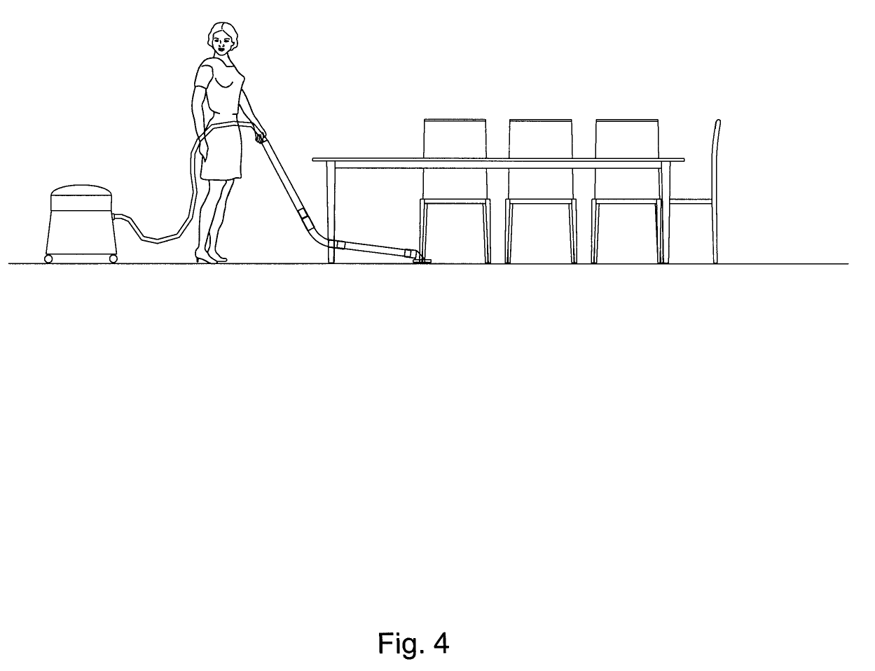

As shown in FIG. 4, an environment of use whereby the user may apply pressure, commence flexation of the article, and reach with rigid hoses underneath articles.

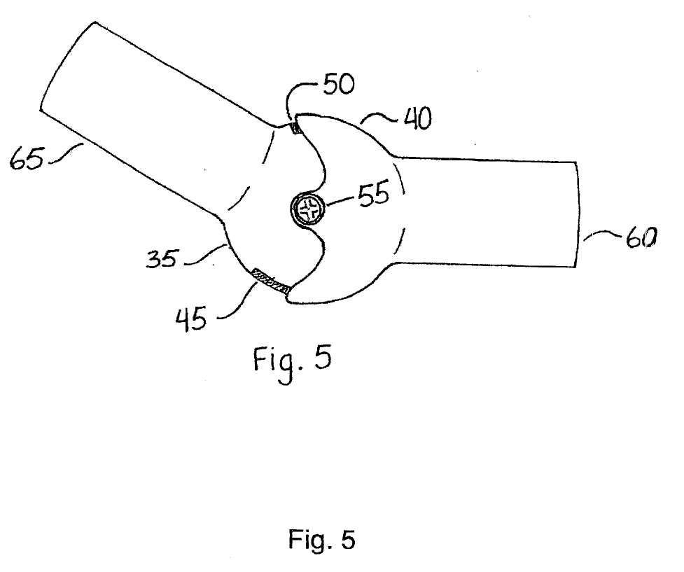

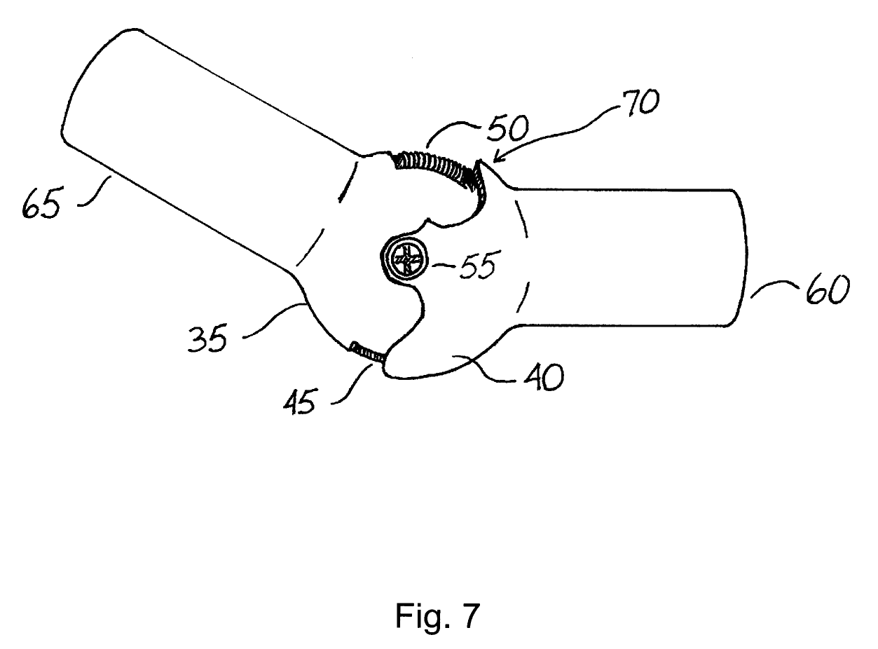

FIG. 5 shows an embodiment of the present invention whereby the flexible columnar body has incorporated into the coupling, a ball and socket type arrangement. In this arrangement there is a first column portion 60 and a second column portion 65. First column portion 60 terminates at an outer ball portion 40 and second column portion 65 terminates at inner ball portion 35. Second column portion 65 terminates and inner ball portion 35 connects at pivot connection 55 whereby rotational motion occurs until guide stop 45 prohibits further rotation. In a preferred embodiment, the coupling in this embodiment will have an angle of flexation between 180°-90°. An interior spring (depicted in FIG. 7) keeps the angle of flexation at a linear or 180 configuration, and application of pressure causes flexation. The coupling returns to 180 configuration by application of force from an inner spring and is guided into position by spring return guide 50.

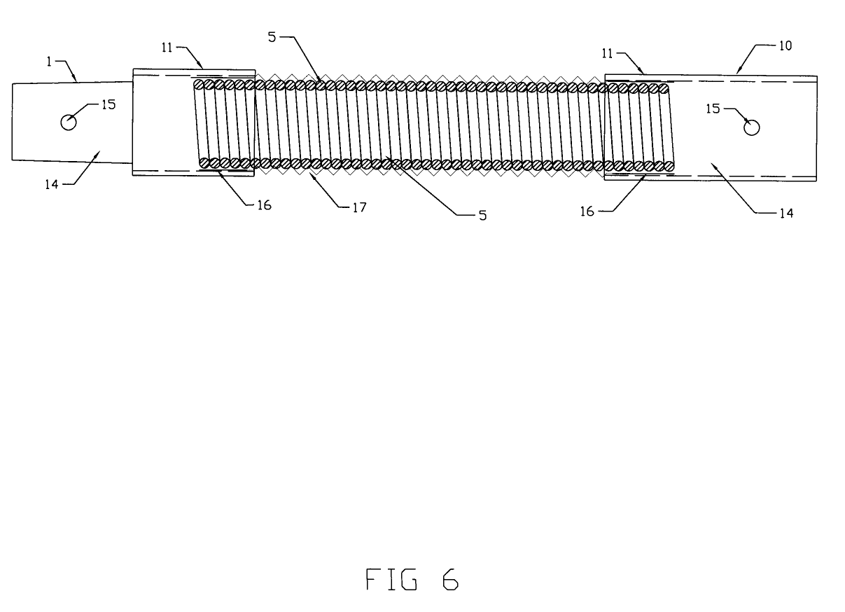

FIG. 6 shows a top perspective view of the coupling of the present invention.

FIG. 7 show a cut away view whereby spring 70 is incorporated into the arrangement so the removal of force allows said spring to return the coupling to a 180° configuration.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1-17. (canceled)

18. A method for using vacuum cleaner comprising:
(a) providing a vacuum hose coupling having a first receiving end and a second receiving end, wherein said coupling maintains a linear orientation when no force is applied to the coupling and said coupling flexes in a central region upon application of pressure on one of said ends;
(b) attaching a first rigid vacuum wand to a first end of said vacuum coupling, said first rigid house having a conventional vacuum article attached thereto on an end opposite said attaching;
(b) attaching a second rigid vacuum wand to a second end of a vacuum coupling;
(c) attaching one end of said second rigid vacuum wand to a source of vacuum from a conventional vacuum cleaner;
(d) applying pressure on one of said coupling ends, said application of pressure flexes said coupling in a central region of said coupling, wherein said flexing imparts an orientation in which an angle of flexation is imparted on said coupling;
(d) using said first and said second rigid vacuum wands connected with said flexed coupling to vacuum under articles with clearance between said article and a vacuuming surface.

19. The method of claim 18 wherein said coupling flexes when pressure is applied, said flexing providing for the vacuuming under articles with said first rigid wand.

20. The method of claim 18 where said vacuuming under articles is carried out by said coupling flexing with an angle of flexation between 180 and 90 and said angle of flexation directing said first rigid wand under said articles and allows a user to reach underneath said articles while said user remains in a standing upright position.

21. The method of claim 18 wherein said coupling returns to a linear orientation after said flexing.

22. The method of claim 18 wherein said coupling is selected from: a unitary structure whereby said unitary structure is in a linear configuration in the absence of pressure on either of said first or said second end; or a two piece structure having an arrangement for flexation in a central region.
